(19) United States
(12) Patent Application Publication
(10) Pub. No.: US 2013/0045783 A1
(43) Pub. Date: Feb. 21, 2013

(54) GAME SYSTEM AND CONTROL METHOD OF CONTROLLING COMPUTER USED THEREFOR

(71) Applicants: Takao Yamamoto, Tokyo (JP); Masahiro Kiyomoto, Tokyo (JP); Yoshitaka Nishimura, Tokyo (JP); Shota Katagiri, Tokyo (JP)

(72) Inventors: Takao Yamamoto, Tokyo (JP); Masahiro Kiyomoto, Tokyo (JP); Yoshitaka Nishimura, Tokyo (JP); Shota Katagiri, Tokyo (JP)

(21) Appl. No.: 13/643,496

(22) PCT Filed: Apr. 27, 2011
(86) PCT No.: PCT/JP2011/060320

§ 371 Date: Oct. 25, 2012

(30) Foreign Application Priority Data
Apr. 28, 2010 (JP) 2010-104543

(51) Int. Cl. A63F 13/06

(52) U.S. Cl. 463/7

(57) ABSTRACT

Disclosed is a game system provided with a monitor for displaying and outputting a game screen, a touch panel overlaid upon the monitor, and an external storage device for storing sequence data wherein operation periods of the touch panel during a game and information specifying any of a plurality of objects are associated and described. In addition, the game system displays, upon the monitor, a game area around which two operation reference units have been set and moves the plurality of objects for designating operation for each of the operation reference units between the operation reference units while displaying the plurality of objects, and if a specific condition has been satisfied, moves and displays each of objects so that the following object overtakes the leading object.

### TECHNICAL FIELD

The present invention relates to a game system in which an operation timing of an operating unit provided in an input device is indicated to a player, and a control method used for the same.

### BACKGROUND ART

There are game machines in which a plurality of players alternately operates an operating unit in tune with a rhythm of music. Of the game machines, there has been known a game machine in which a plurality of players plays a game, and each player alternately operates an operating unit while deciding a next player to operate an operating unit through an operation of an operating unit (for example, see Patent Literature 1). Further, there has been known a game machine in which a game is played such that two players alternately hit back an object indicating an operation timing, and the velocity of an object moving toward the other party changes according to the position of an object at a point in time when each player hits an object back (for example, see Patent Literature 2).

Patent Literature 1: Japanese Patent Application Laid-Open (JP-A) No. 2003-236243 and Patent Literature 2: JP-A No. 2000-155543.

### SUMMARY OF INVENTION

### Technical Problem

In the game machine disclosed in Patent Literature 1, a difficulty level of the game uniformly increases due to an increase in the number of light shots indicating an operation timing of the operating unit, an increase in the tempo of a rhythm of music, or the like. For this reason, a difficulty level of the game of each player uniformly increases. Meanwhile, in the game machine disclosed in Patent Literature 2, a moving velocity of an object moving toward one player changes according to the position of an object at the time of an operation of the other player. For this reason, the other player can change a difficulty level of a game of one player. However, in the game machine disclosed in Patent Literature 2, an element changing the difficulty level of the game of an opponent player is limited to the velocity of the object.

In this regard, it is an object of the present invention is to provide a game system which is capable of variously changing a difficulty level of a game and a control method of controlling a computer.

### Solution to Problem

A game system of the present invention comprises: a display device that displays and outputs a game screen; an input device including at least one operating unit; a sequence data storage device that stores sequence data in which an operation timing on the operating unit during a game is described; a game region presenting device that causes a game region in which a plurality of reference portions arranged apart from each other are set to be displayed on the game screen of the display device; and a mark display control device that displays an operation indication mark for indicating an operation on the operating unit while moving the operation indication mark in the game region such that the operation indication mark arrives at at least one of the plurality of reference portions at an operation timing indicated by the sequence data, wherein mark information designating any one of a plurality of operation indication marks is further described in the sequence data in association with each operation timing, and the mark display control device causes the plurality of operation indication marks respectively corresponding to operation timings to be displayed based on the mark information of the sequence data, switches a timing to arrive at a reference portion between an operation indication mark corresponding to a certain operation timing displayed on the game region and an operation indication mark corresponding to a subsequent operation timing to arrive at the reference portion at which the certain operation timing is to arrive subsequently to the certain operation timing when a specific condition is satisfied, and displays the operation indication marks while moving the operation indication marks such that the operation indication mark corresponding to the certain operation timing arrives at the reference portion at an arrival position at the subsequent operation timing, and the operation indication mark corresponding to the subsequent operation timing arrives at the reference portion at the arrival position at the certain operation timing.

According to the present invention, when a specific condition is satisfied, an arrival timing of an operation indication mark corresponding to a certain operation timing displayed on a game region is switched with an arrival timing of an operation indication mark which is an operation to arrive at an operation reference portion at the certain operation timing and corresponds to an operation timing subsequent to the certain operation timing. The operation indication mark corresponding to the certain operation timing in the game region is moving to the operation reference portion ahead of the operation indication mark corresponding to the subsequent operation timing in order to arrive at the operation reference portion before the subsequent operation timing. For this reason, by switching of arrival timings, the operation indication mark corresponding to the certain operation timing which is moving ahead decreases in moving velocity to arrive at the operation reference portion at the subsequent operation timing, whereas the operation indication mark corresponding to the subsequent operation timing positioned behind the operation indication mark corresponding to the certain operation timing increases in moving velocity to arrive at the operation reference portion at the certain operation timing. As a result, an effect by which the following operation indication mark overtakes the preceding operation indication marks can be rendered. Further, since a difficulty level of the game can be increased by switching the arrival timing of the preceding operation indication mark with the arrival timing of the following operation indication mark, it is possible to provide wide ways for changing the difficulty level of the game. Thus, the difficulty level of the game can be variously changed. Further, as a result, amusement of the game can be improved.

In an aspect of the game system according to the present invention, the mark display control device may determine that the specific condition has been satisfied when at least a specific operation has been executed on the operating unit. In this case, depending on the presence or absence of the specific operation, the arrival timing of the operation indication mark corresponding to the certain operation timing can be switched with the arrival timing of the operation indication mark corresponding to the subsequent operation timing. Thus, the difficulty level of the game can be changed depending on the presence or absence of the specific operation.

Various operations may be applied as the specific operation. For example, in an aspect of the game system according to the present invention, the mark display control device may determine that the specific operation has been executed when an operation designating at least one of a predetermined direction and a predetermined velocity has been executed. Further, whether or not the predetermined direction and the predetermined velocity have been designated can be determined in various manners. For example, in an aspect of the game system according to the present invention, the input device may be configured so as to detect an operation position of an operation on the operating unit, and the mark display control device may determine whether or not the predetermined direction has been designated based on a direction in which the operation position continuously changes and whether or not the predetermined velocity has been designated based on the velocity of a change at which the operation position continuously changes, with reference to a detection result of the input device.

Further, in an aspect in which the presence or absence of execution of the specific operation is included in the specific condition, the mark display control device may determine that the specific condition has been satisfied when a position condition that the operation indication mark corresponding to the certain operation timing is positioned at a predetermined position of the game region when the specific operation is executed has been further satisfied. In this case, when the position condition is not satisfied, switching of arrival timings of both operation indication marks is not executed, and thus a change in the moving times of both operation indication marks can be restricted within a predetermined range. Thus, the moving velocity of the operation indication mark corresponding to the certain operation timing and the moving velocity of the operation indication mark corresponding to the subsequent operation timing can be prevented from being changed to a predetermined level or more.

Any position may be applied as the predetermined position of the position condition as far as a change in the moving time of the operation indication mark is restricted within a predetermined range. For example, in an aspect of the game system according to the present invention, the game region presenting device may cause a region in which a plurality of reference portions extending in the form of a straight line are set apart from each other to be displayed as the game region, the mark display control device may determine that the operation indication mark is positioned at the predetermined position and determine that the position condition is satisfied when the specific operation is executed and the operation indication mark corresponding to the certain operation timing is positioned at a side of a specific reference portion used to indicate an operation on the operating unit on which the specific operation is executed further than a center line which is in parallel with the specific reference portion and arranged at the position at which the game region is equally divided in half.

Further, in an aspect in which the presence or absence of execution of the specific operation and the position condition are included in the specific condition, the mark display control device may display the operation indication mark such that the operation indication mark corresponding to the subsequent operation timing moves along a moving path having a moving distance of a predetermined distance or more when the specific operation is executed but the position condition is not satisfied. In this case, since the position condition is not satisfied, switching of the arrival timings of both operation indication marks is not executed. Meanwhile, it is possible to move the operation indication mark corresponding to the subsequent operation timing by the moving distance of the predetermined distance or more in response to the specific operation. Since the arrival timing is not changed, when the moving distance is changed, the moving velocity is changed. Thus, the moving velocity of the operation indication mark can be prevented from being changed to a certain level or more, and the moving velocity of the operation indication mark corresponding to the subsequent operation timing can be increased to be a predetermined velocity or more in response to the specific operation.

In an aspect of the game system according to the present invention, the input device may include a plurality of operating units, an operation timing on each of the plurality of operating units during the game may be described in the sequence data in association with information indicating any one of the plurality of operating units, the game region presenting device may cause a game region in which each of reference portions respectively corresponding to the plurality of operating units among the plurality of reference portions is set as an operation reference portion to be displayed on the game screen of the display device, the mark display control device may display the operation indication mark while moving the operation indication mark in the game region such that the operation indication mark arrives at the operation reference portion corresponding to the operating unit associated with an operation timing indicated by the sequence data at the operation timing, and may display each operation indication mark while moving each operation indication mark such that when the specific condition is satisfied, a timing to arrive at the operation reference portion is switched between the operation indication mark corresponding to the certain operation timing and the operation indication mark corresponding to the subsequent operation timing, the operation indication mark corresponding to the certain operation timing arrives at the operation reference portion at the arrival position at the subsequent operation timing, and the operation indication mark corresponding to the subsequent operation timing arrives at the operation reference portion at the arrival position at the certain operation timing. In this case, in a game that includes a plurality of operating units and can be played by a plurality of players, the difficulty level of the game can be increased by switching the arrival timing of the preceding operation indication mark with the arrival timing of the following operation indication mark, and thus it is possible to provide wide ways for changing the difficulty level of the game. Thus, in the game which can be played by the plurality of players, the difficulty level of the game can be variously changed. Incidentally, all or a part of the plurality of reference portions may be set as the operation reference portion.

Various input devices may be used as the input device. For example, in an aspect of the game system according to the present invention, a touch panel arranged on the display device so as to cover the game region may be used as the input device.

The game region may have various shapes. For example, in an aspect of the present invention, the game region presenting device may cause a region which is formed in the form of a quadrangle and includes two operation reference portions extending in the form of a straight line which are set at both one ends of the quadrangle to face each other to be displayed on a screen of the display device as the game region. In this case, for example, it is possible to actualize a game of a match-up type, which is played by two players respectively corresponding to the operation reference portions at both ends of the quadrangle, in which the moving velocity of the operation indication mark moving between both operation reference portions changes when a specific condition is satisfied.

In an aspect of the game system according to the present invention, the game system may further comprise an evaluating device that evaluates an operation in at least one operating unit based on a timing of an operation on the operating unit and an operation timing designated by the sequence data. In this case, a timing of an operation on each operating unit can be evaluated based on an operation timing described in the sequence data. Thus, amusement of the game can be further improved.

In an aspect of the game system according to the present invention, the game system may further comprises: an audio output device that reproduces and outputs a sound; a music data storage device that stores music data used to reproduce music; and a music reproducing device that reproduces the music through the audio output device based on the music data, and wherein an operation timing of each of the plurality of operating units during reproduction of the music may be described in the sequence data. In this case, it is possible to actualize a music game in which the operation indication mark moves between the operation reference portions so as to arrive at the operation reference portion corresponding to the operation timing at the operation timing corresponding to a rhythm of music, and the moving velocity of the operation indication mark moving between the operation reference portions changes when a specific condition is satisfied.

A control method of controlling a computer of the present invention is a control method of controlling a computer incorporated into a game machine comprising: a display device that displays and outputs a game screen; an input device including at least one operating unit; a sequence data storage device that stores sequence data in which an operation timing on the operating unit during a game is described, wherein the control method of controlling the computer comprises the steps: a game region presenting step that causes a game region in which a plurality of reference portions arranged apart from each other are set to be displayed on the game screen of the display device; and a mark display control step that displays an operation indication mark for indicating an operation on the operating unit while moving the operation indication mark in the game region such that the operation indication mark arrives at at least one of the plurality of reference portions at an operation timing indicated by the sequence data, wherein mark information designating any one of a plurality of operation indication marks is further described in the sequence data in association with each operation timing, and the mark display control step further includes a step that causes the plurality of operation indication marks respectively corresponding to operation timings to be displayed based on the mark information of the sequence data, switches a timing to arrive at a reference portion between an operation indication mark corresponding to a certain operation timing displayed on the game region and an operation indication mark corresponding to a subsequent operation timing to arrive at the reference portion at which the certain operation timing is to arrive subsequently to the certain operation timing when a specific condition is satisfied, and displays the operation indication marks while moving the operation indication marks such that the operation indication mark corresponding to the certain operation timing arrives at the reference portion at an arrival position at the subsequent operation timing, and the operation indication mark corresponding to the subsequent operation timing arrives at the reference portion at the arrival position at the certain operation timing. It is possible to actualize the game system of the present invention by executing the control method of controlling the computer of the present invention.

### Advantageous Effects of Invention

As described above, according to the present invention, it is possible to variously change a difficulty level of a game.

### BRIEF DESCRIPTION OF DRAWINGS

FIG. 1 is a diagram illustrating a game machine for business use to which a game system according to an embodiment of the present invention is applied.

FIG. 2 is a functional block diagram of a game machine.

FIG. 3 is a diagram schematically illustrating a game screen.

FIG. 4 is a diagram for describing a region of an object.

FIG. 5 is a diagram schematically illustrating a game screen of a state in which two objects are displayed on a game region.

FIG. 6 is a diagram illustrating an example of a moving path of an object when a moving velocity becomes fast by a smash operation.

FIG. 7 is a diagram schematically illustrating a game screen when a following object has overtaken a preceding object.

FIG. 8 is a diagram illustrating an example of content of sequence data.

FIG. 9 is a diagram illustrating an example of a flowchart of a sequence process routine

FIG. 10 is a diagram illustrating an example of a flowchart of a path decision process routine.

FIG. 11 is a diagram illustrating an example of a flowchart of an overtaking process routine.

FIG. 12 is a diagram illustrating an example of a flowchart of an operation evaluation routine.

### DESCRIPTION OF EMBODIMENTS

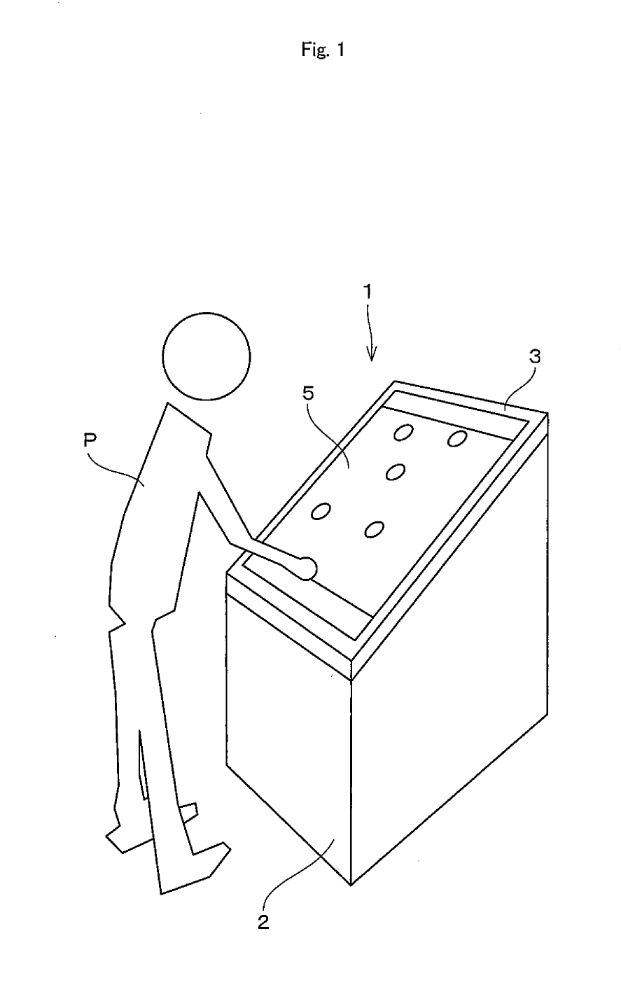

Hereinafter, an embodiment of a game system according to the present invention will be described. FIG. 1 is a diagram illustrating a game machine for business use to which a game system according to an embodiment of the present invention is applied. As illustrated in FIG. 1, a game machine 1 includes a casing 2, and a monitor 3 arranged, obliquely toward a player P side, on the top surface of the casing 2. A transparent touch panel 5 is superimposed on the surface of the monitor 3. The touch panel 5 is a known input device that outputs a signal corresponding to a contact position when the player P contacts the touch panel 5 with his/her finger or the like. In addition, the game machine 1 includes various kinds of input devices and output devices provided in a typical game machine for business use such as a button used to make a selection or a decision, a power switch, a volume operation switch, and a power lamp, which are not illustrated in FIG. 1.

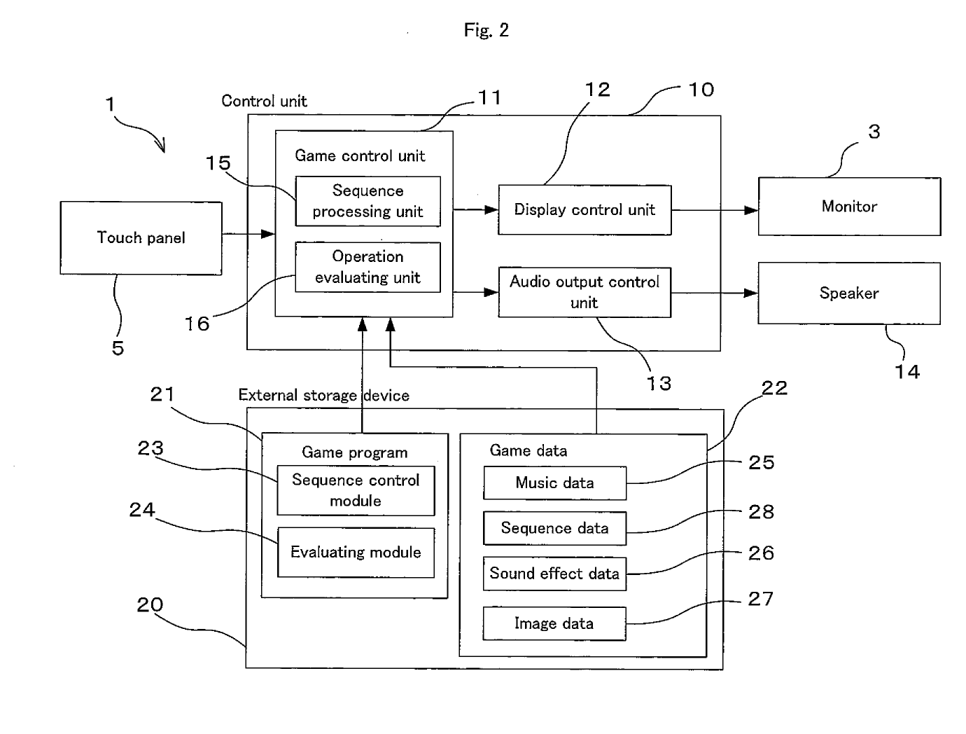

FIG. 2 is a functional block diagram of the game machine 1. As illustrated in FIG. 2, a control unit 10 serving as a computer is provided in the casing 2. The control unit 10 includes a game control unit 11 serving as a control host, a display control unit 12 and an audio output control unit 13 which operate according to an output from the game control unit 11. The game control unit 11 is configured as a unit in which a microprocessor is combined with various kinds of peripheral devices such as an internal storage device (for example, a read only memory (ROM) or a random access memory (RAM)) necessary for an operation of the microprocessor. The display control unit 12 causes a predetermined image to be displayed on the monitor 3 by rendering an image corresponding to image data provided from the game control unit 11 in a frame buffer and then outputting a video signal corresponding to the rendered image to the monitor 3. The audio output control unit 13 causes a predetermined sound (including music or the like) to be reproduced from a speaker 14 by generating an audio reproduction signal corresponding to audio reproduction data provided from the game control unit 11 and then outputting the generated audio reproduction signal to the speaker 14.

The game control unit 11 is connected with an external storage device 20. As the external storage device 20, there is used a storage medium in which data remains stored even when power is not supplied such as an optical storage medium including a digital versatile disc-read only memory (DVD-ROM), a compact disc-read only memory (CD-ROM) or the like, or a non-volatile semiconductor memory device including an electrically erasable programmable read-only memory (EEPROM) or the like.

A game program 21 and game data 22 are stored in the external storage device 20. The game program 21 is a computer program necessary for the game machine 1 to execute a music game according to a predetermined procedure, and includes a sequence control module 23 and an evaluating module 24 in order to actualize a function according to the present invention. When the game machine 1 is activated, the game control unit 11 executes various kinds of initial settings necessary to operate as the game machine 1 by executing an operation program stored in an internal storage device thereof, and then sets an environment in which a music game is executed according to the game program 21 by reading the game program 21 from the external storage device 20 and executing the game program 21. When the sequence control module 23 of the game program 21 is executed by the game control unit 11, a sequence processing unit 15 is generated in the game control unit 11. Further, when the evaluating module 24 of the game program 21 is executed by the game control unit 11, an operation evaluating unit 16 is generated in the game control unit 11. The sequence processing unit 15 and the operation evaluating unit 16 are logical devices actualize by a combination of computer hardware and a computer program. The sequence processing unit 15 executes music game processes such as a process of instructing the player to make an operation in tune with reproduction of music (music composition) selected by the player or generating a sound effect in response to the player's operation. The operation evaluating unit 16 executes processes such as a process of evaluating the player's operation and then controlling the game based on an evaluation result. Incidentally, the game program 21 includes various kinds of program modules necessary to execute a music game in addition to the modules 23 and 24, and logical devices corresponding to the modules are generated in the game control unit 11 although not illustrated.

The game data 22 includes various pieces of data to be referred to when a music game is executed according to the game program 21. For example, the game data 22 includes music data 25, sound effect data 26, and the image data 27. The music data 25 refers to data necessary for reproducing and outputting music which is a target of the game from the speaker 14. FIG. 2 illustrates a single kind of music data 25, but the player can actually select music to be played from among a plurality of pieces of music. In the game data 22, one or more pieces of music data 25 are recorded in association with information identifying each piece of music. The sound effect data 26 is data in which each of one or more types of sound effects to be output from the speaker 14 in response to the player's operation is recorded in association with a unique code for each of the sound effects. Sounds of musical instruments and various kinds of sounds are included as the sound effect. Pieces of sound effect data which are equal in number to a predetermined octave number and have different musical pitches according to the kind may be prepared. The image data 27 is data used to cause a background image, various kinds of objects or icons, and the like in a game screen to be displayed on the monitor 3.

The game data 22 further includes sequence data 28. The sequence data 28 is data used to define an operation to be indicated to the player. At least a piece of sequence data 28 is prepared for single music data. The details of the sequence data 28 will be described later.

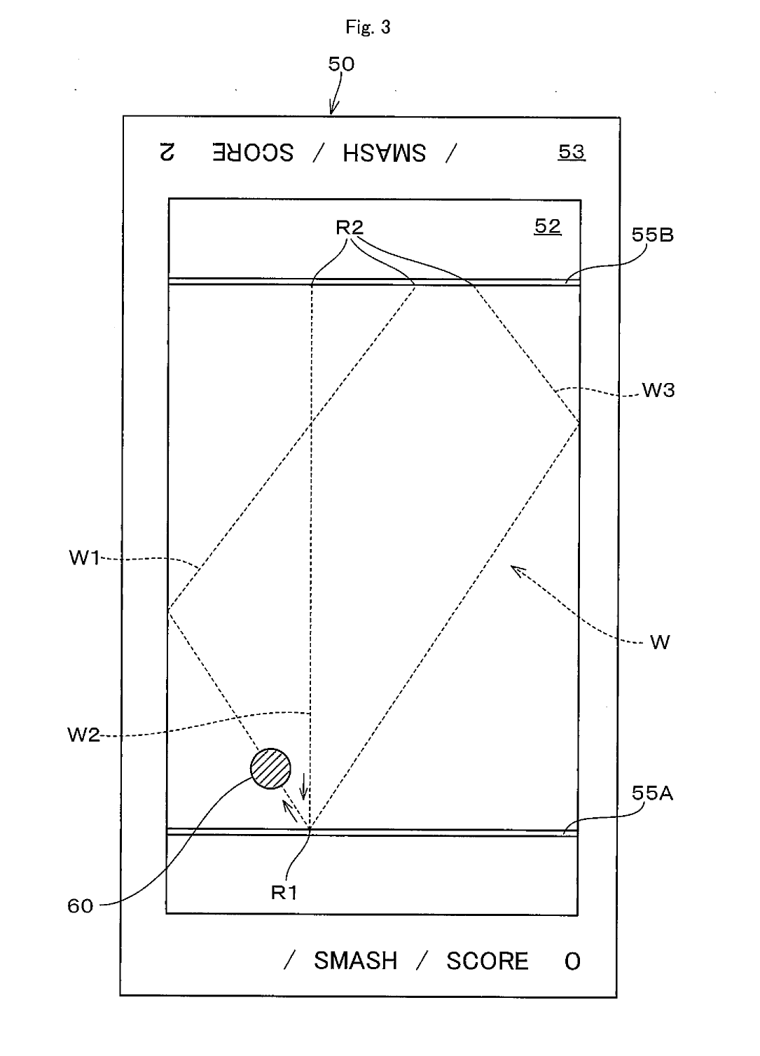

Next, an outline of a music game executed by the game machine 1 will be described. The game machine 1 is configured as a music game machine of a match-up type in which the two players execute an operation in tune with music (including a case in which the game machine 1 functions as the other player) and the operation timings of two players are evaluated. FIG. 1 illustrates only one game machine, but the game may be played through a plurality of game machines 1 connected so as to share the game situation. FIG. 3 is a diagram schematically illustrating a game screen. The game screen 50 includes a game region 52 used to guide an operation timing to the player and an information region 53 used to display a score and the like of each player. The game region 52 has a rectangular shape. A first operation reference portion 55A and a second operation reference portion 55B serving as an operation reference portion are arranged at both ends of the game region 52 in a longitudinal direction so as to face each other. Each of the operation reference portions 55A and 55B extends in the form of a straight line in a direction orthogonal to the longitudinal direction of the game region 52. Each of the operation reference portions 55A and 55B is used as a reference of a current time on the game by a player of the game. Specifically, the first operation reference portion 55A is used as a reference of a current time of a first player, and the second operation reference portion 55B is used as a reference of a current time of a second player. In the example of FIG. 3, a red straight line is used as the first operation reference portion 55A, and a blue straight line is used as the second operation reference portion 55B, and different colors for each player are used for identifying each player. Further, the information region 53 is arranged around the game region 52. One end side of the game region 52 in the longitudinal direction is used for displaying a score and the like of one player, and the other end side thereof is used for displaying a score and the like of the other player.

Each of the operation reference portions 55A and 55B includes a plurality of rebounding points arranged at predetermined intervals. The plurality of rebounding points R1 included in the first operation reference portion 55A are connected with rebounding points R2 included in the second operation reference portion through a plurality of paths W. In other words, provided are a plurality of paths W that reach from one rebounding point R1 included in the first operation reference portion 55A to a plurality of rebounding points R2 included in the second operation reference portion. The three dashed lines illustrated in FIG. 3 represent three paths W1, W2, and W3 all of which connect the rebounding point R1 with the rebounding point R2. In the example of FIG. 3, any one rebounding point R1 of the first operation reference portion 55A has the three paths W1, W2, and W3 that extend from the rebounding point R1 to the three rebounding points R2 included in the second operation reference portion 55B. During execution of the music game, that is, during the progress of reproduction of music, an object 60 serving as the operation indication mark indicating an operation is displayed on the path W connecting the rebounding point R1 with the rebounding point R2 according to the sequence data 28. Incidentally, in FIG. 3, for convenience of description, the paths W1, W2, and W3 are denoted by the dashed lines, but none of the plurality of paths W is displayed on the actual game screen 50.

The object 60 appears at the rebounding point R1 or the rebounding point R2 at an appropriate timing in music, and then moves along the path W extending from the rebounding point R1 or R2 at the appearance position from one of the rebounding points R1 and R2 at the appearance position toward the other of the rebounding points R1 and R2 positioned at the opposite side according to the progress of the music. Then, the rebounding point R1 or R2 at which the object 60 has arrived serves as an appearance position of a next object 60, and the next object 60 moves from the appearance position toward the rebounding point R1 or R2 positioned at the opposite side. For this reason, the object 60 alternately rebounds from the rebounding points R1 and R2 and repeatedly moves between the operation reference portions 55A and 55B. Further, each player using the operation reference portion 55A or 55B at which the object 60 has arrived as the reference of the current time is required to perform a touch operation of touching the position of the operation reference portion 55A or 55B at which the object 60 has arrived in tune with an arrival of the object 60 at the operation reference portion 55A or 55B. When each player performs the touch operation, a time difference between a time when the object 60 matches each of the operation reference portions 55A and 55B and a time when each player has performed the touch operation is detected. The smaller the time difference is, the higher an operation of the player is evaluated. Further, a sound effect is reproduced from the speaker 14 in response to the touch operation. A well-known method may be used as a method of reproducing the sound effect. For example, as a well-known method of reproducing a sound effect, there is a method of adding a sound effect on music while reproducing the music or a method of reproducing a sound effect corresponding to a misoperation while muting the music when missed. Further, for example, there is also a method in which music is divided in parts, each part is assigned to each operation timing, and a part of the music assigned to the corresponding operation timing is played back when an appropriate operation is executed (a method of forming the music by an appropriate operation at each operation timing. For this reason, when a misoperation is made, a part of the music to which the operation timing is assigned is not reproduced).

In the example of FIG. 3, the object 60 is on the path W2 immediately before arriving at the rebounding point R2 of the second operation reference portion 55B. At this time, it is preferable that the second player using the second operation reference portion 55B as the reference of the current time performs the touch operation at the position of the second operation reference portion 55B at which the object 60 arrives in tune with an arrival at the second operation reference portion 55B. Further, the object 60 is displayed in color corresponding to the operation reference portion 55A or 55B of a destination toward which the object 60 is currently moving. In other words, in the example of FIG. 3, the object 60 is displayed in blue until arriving at the rebounding point R2 of the second operation reference portion 55B, and a next object 60 appearing at the rebounding point R2 at the arrival position is displayed in red. In this embodiment, a plurality of operating units are configured by a combination of each of the operation reference portions 55A and 55B on the monitor 3 and the touch panel 5 superimposed thereon. Incidentally, in the following, each of the operation reference portions 55A and 55B may be used as a term representing the operating unit.

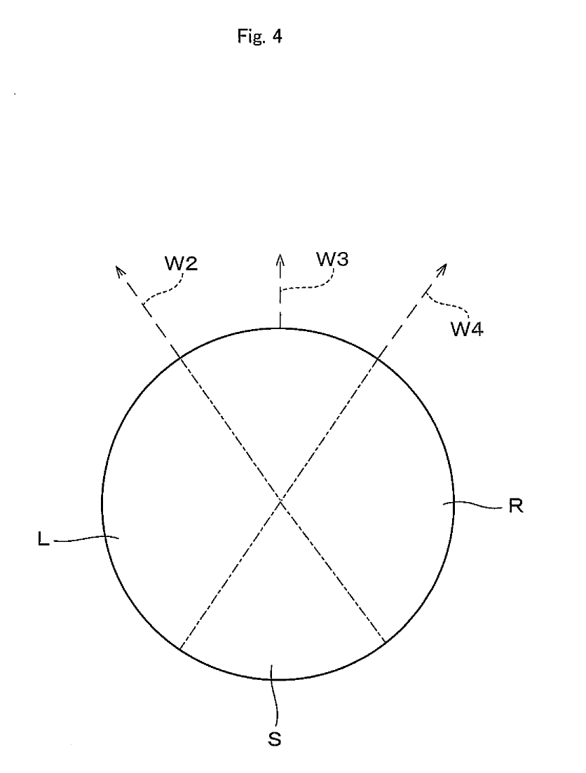

The path W along which the object 60 moves from one of the rebounding points R1 and R2 at the arrival position to the other of the rebounding points R1 and R2 at the opposite side is decided according to the position of the object 60 when the operation reference portion 55A or 55B is touched. In order to make a comparison of position easy, the object 60 is divided into a plurality of regions. FIG. 4 is a diagram for describing regions of the object 60. In FIG. 4, dashed lines represent the paths W1, W2, and W3, and an alternate long and short dash line 62 represents the boundary between the regions. In the example of FIG. 4, the object 60 is divided into four regions, that is, a contact region S near a contact point at which the object 60 first comes in contact with the operation reference portion 55A or 55B, right and left regions R and L that establish the boundary of the contact region S, and the remaining region. And, as a path along which the object 60 moves, from among the paths W reaching to the rebounding point R1 from the rebounding point R2, the straight line path W2 reaching to the rebounding point R1 at the shortest distance is selected when the contact region S or the remaining region is touched, the first right path W3 reaching to the rebounding point R1 through a right side wall 52R of the game region 52 in the longitudinal direction is selected when the left region L is touched, and the first left path W1 reaching to the rebounding point R1 through a left side wall 52L of the game region 52 in the longitudinal direction is selected when the right region R is touched. In other words, the moving path used when the object 60 moves to the operation reference portion 55A or 55B of the next destination is decided according to a positional relation between an operation position of the touch operation and the position of the object 60. Since the moving distance differs according to the moving path, the moving distance along which the object 60 moves to the operation reference portion 55A or 55B of the next destination differs according to the positional relation between the operation position and the position of the object 60. Meanwhile, an operation timing to touch the object 60, that is, a timing at which the object 60 arrives at each of the operation reference portions 55A and 55B is constant regardless of the moving path. For this reason, the moving velocity of the object 60 differs according to the moving path. In other words, the path W and the moving velocity of the object 60 that moves toward one player change according to the other player's touch operation. Thus, this changes a difficulty level of a game, and each player executes his/her operation while being conscious of influence on the other player.

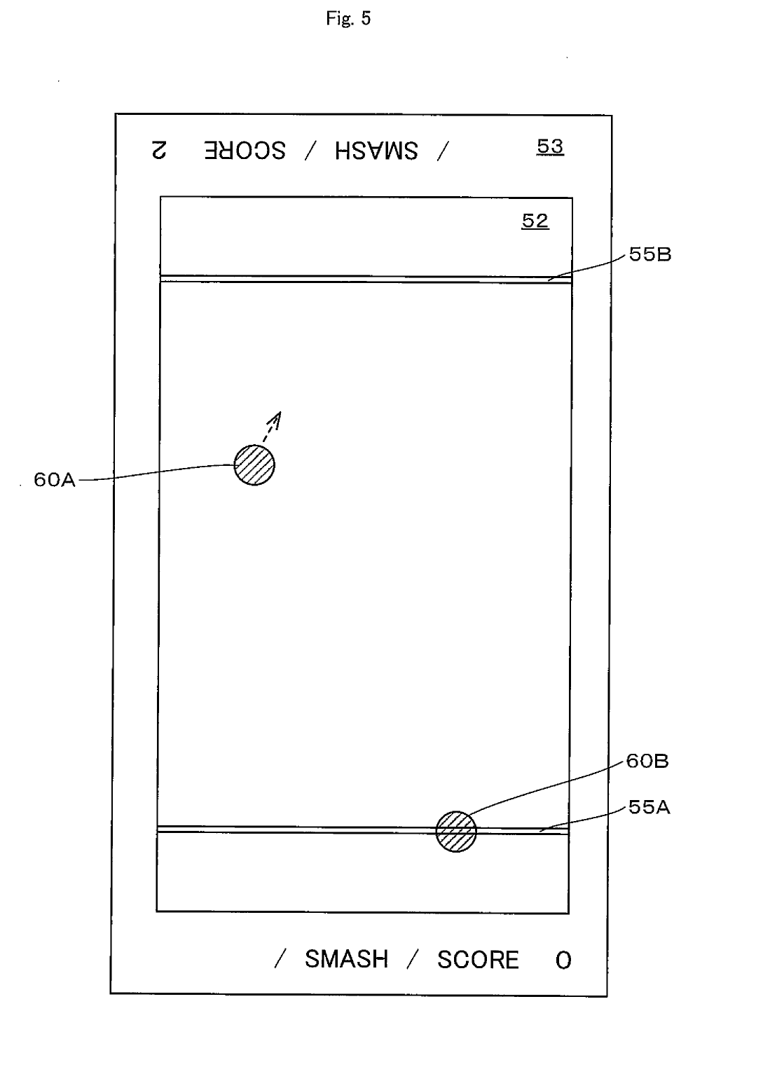

A plurality of objects 60 are appropriately displayed on each path W according to a state of the music or the progress state of the game. FIG. 5 is a diagram schematically illustrating a game screen of a state in which two objects 60 are displayed on the game region 52. In the example of FIG. 5, a first object 60A is displayed in front of the second operation reference portion 55B, and a second object 60B is displayed on the first operation reference portion 55A. The objects 60A and 60B move in the game region 52 to arrive at the operation reference portions 55A and 55B at operation timings which are associated with the objects 60A and 60B, respectively, through the sequence data 28 which will be described later. In the following, when the objects 60A and 60B are not distinguished from each other, the objects 60A and 60B are collectively referred to as the object 60.

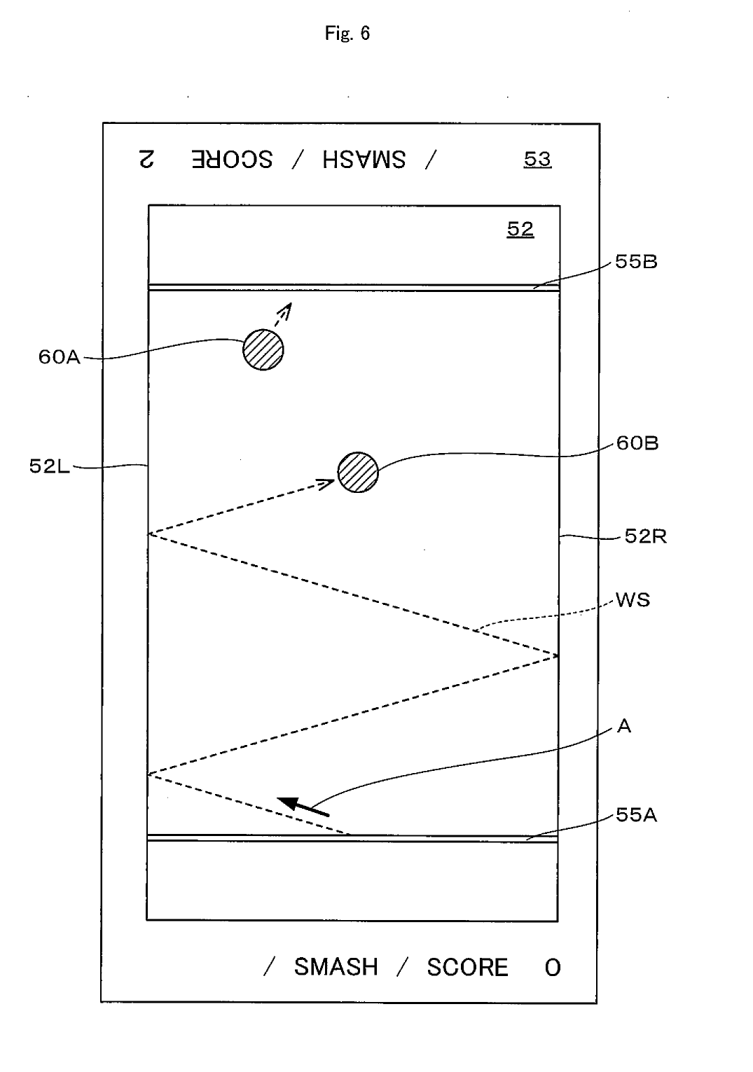

Further, each player can increase the moving velocity of the object 60 moving toward the operation reference portion corresponding to the opponent player by performing the touch operation on the operation reference portion 55A or 55B at which the object 60 has arrived and executing a smash operation as a specific operation of pushing the object 60 in the touched state. An arrival timing at which the object 60 arrives at the operation reference portion 55A or 55B is an operation timing and thus does not change. For this reason, when the smash operation is executed, the object 60 moves along a path having a long moving distance. FIG. 6 is a diagram illustrating an example of the moving path of the object 60 when the moving velocity is increased by the smash operation. In FIG. 6, an arrow A represents a direction of the smash operation, and a dashed line represents a path WS having a long moving distance. In the example of FIG. 6, the touch operation is performed on the position of the first operation reference portion 55A at which the object 60 has arrived in tune with the arrival of the object 60 at the first operation reference portion 55A, and the smash operation of pushing the object 60 in an arrow A direction in the touched state. As a result of this operation, the smashed object 60 moves in the arrow A direction at a high speed. Then, the object 60 moves along the path WS having a long moving distance, in which the object 60 rebounds from both side walls 52L and 52R extending in the longitudinal direction of the game region 52 twice or more, as the moving path having a moving distance of a predetermined distance or more.

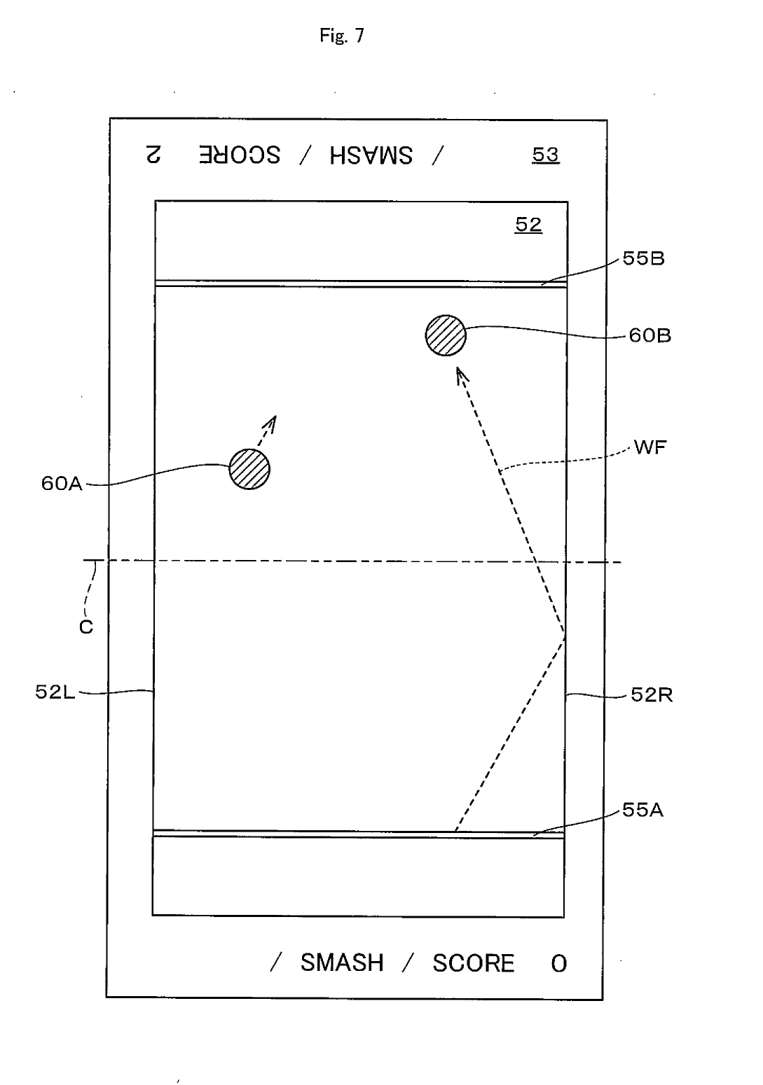

Further, when the smash operation is executed, there may be an object 60 that is moving to the operation reference portion at the opposite side ahead of the smashed object 60. Furthermore, when the smash operation is executed, the preceding object 60 may be positioned in front of the center of the game region 52. In this case, the arrival timing of the smashed following object 60 and the arrival timing of the preceding object 60 are switched with each other, the moving velocity of the preceding object 60 decreases, and the following object 60 moves to overtake the preceding object 60 and then first arrive at the operation reference portion at the opposite side. In other words, when the preceding object 60 is present and the preceding object 60 is positioned in front of the center of the game region 52, an operation timing indicated by the following object 60 is switched with an operation timing indicated by the preceding object 60 due to the smash operation. FIG. 7 is a diagram schematically illustrating a game screen when the following object 60 has overtaken the preceding object 60. In the example of FIG. 7, when the smash operation is performed on the following object 60B, the preceding object 60A moving toward the second operation reference portion 55B was positioned at the first operation reference portion 55A side further than the center line C of the game region 52. In FIG. 7, an alternate long and two short dashes line represents a center line C. The center line C is positioned at the center of the game region 52, and extends in parallel with the operation reference portions 55A and 55B to equally divide the game region 52 in half. For this reason, the following object 60B overtakes the preceding object 60A in order to arrive at the second operation reference portion 55B at an operation timing which was supposed to be originally indicated by the preceding object 60A before the smash operation. At this time, the following object 60B moves along an overtaking path WF as the moving path used to overtake the preceding object 60A. Meanwhile, the overtaken preceding object 60A decreases in the moving velocity to arrive at the second operation reference portion 55B at an operation timing which was supposed to be originally indicated by the following object 60B before the smash operation. As described above, each player plays a game under influence of an operation of the opponent player. Incidentally, in FIG. 7, for the sake of description, the center line C is illustrated, but the center line C is not displayed on an actual game screen. The center line C functions as a determination criterion to suppress an abrupt change in the moving velocity of the object 60. However, a configuration to determine whether or not to execute an overtaking operation using the center line C as a reference may not be provided. In this case, an object 60 whose moving velocity abruptly changes may be intentionally generated.

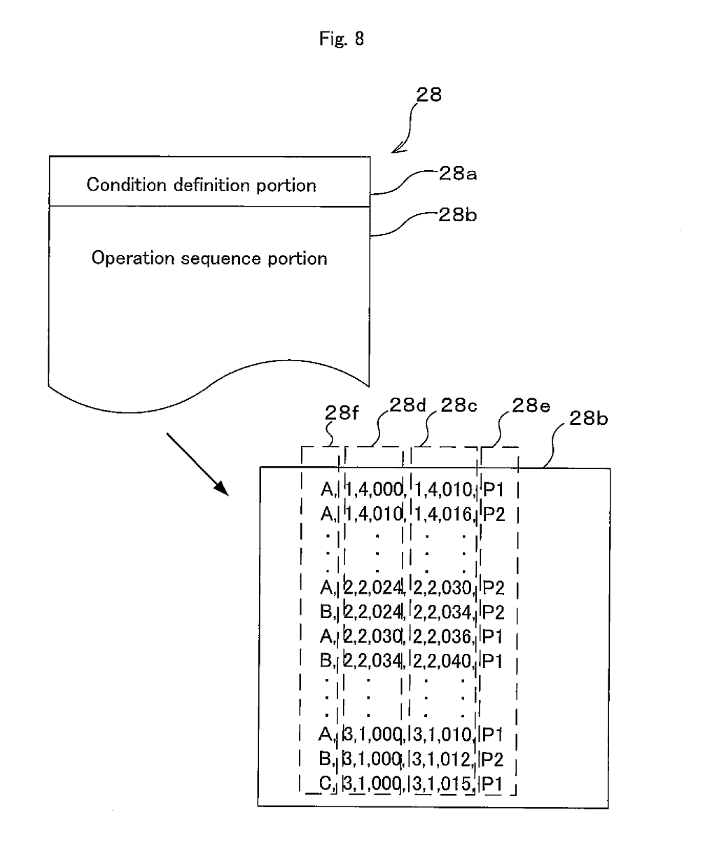

Next, the details of the sequence data 28 will be described with reference to FIG. 8. The sequence data 28 includes a condition definition portion 28a and an operation sequence portion 28b as illustrated in FIG. 8. The condition definition portion 28a includes information described to designate an execution condition of the game that differs according to the music, such as information designating the tempo, a beat, and a track of the music, and a sound effect to be generated when the touch operation is performed on the object 60. Incidentally, in FIG. 8, the condition definition portion 28a is included only in the head portion of the sequence data 28, but the condition definition portion 28a may be added to an appropriate intermediate position of the operation sequence portion 28b. Thus, processing of changing the tempo in the music, an assignment of the sound effect, or the like can be actualized.

Meanwhile, in the operation sequence portion 28b, a timing to touch the object 60, a display start timing, and information indicating a player (or each of the operation reference portions 55A and 55B) are described in association with one another for each object 60. FIG. 8 is a diagram illustrating an example of content of the sequence data. As partially illustrated in FIG. 8, the operation sequence portion 28b includes an operation timing portion 28c that indicates a timing (operation timing) to make an operation in music, a display start information portion 28d setting a display start timing to start a display of the object 60, a display position indication portion 28e that indicates a player (or each of the operation reference portions 55A and 55B) in which the object 60 starts to be displayed, and a mark information portion 28f indicating the object 60 to be displayed. And, the operation sequence portion 28b is configured as a set of a plurality of records in which an operation timing to perform an operation in music, a display start timing of the object 60, and a player (or each of the operation reference portions 55A and 55B) in which the object 60 starts to be displayed are described in association with one another for each object 60 to be displayed. The operation timing and the display start timing are described such that a bar number in music, a beat number, and a value representing a time in a beat are separated by a comma. A time in a beat refers to an elapsed time from the head of one beat, and is represented by the number of units, from the head of the one beat, obtained by equally dividing the length of the one beat into n unit times. For example, when a time in which n is 100, and ¼ elapses from the head of a second beat in the second beat of a first bar of music is designated as an operation timing or a display start timing, “01,2,025” is described.

An indication of players in which the object 60 starts to be displayed is described as “P1” when the first player is indicated. And an indication of players in which the object 60 starts to be displayed is described as “P2” when the second player is indicated. Incidentally, the indication of the player corresponds to an indication of a color of the object 60 to be displayed. For example, a blue object 60 is displayed when “P1” is described, and a red object 60 is displayed when “P2” is described.

In the mark information portion 28f, for example, a letter A is described as information indicating the object 60 to be displayed. “A” is used as a letter corresponding to the first object 60 to be displayed on the game region 52, “B” is used as a letter corresponding to the second object 60, and “C” is used as a letter corresponding to the third object 60. In other words, various kinds of letters according to the number of objects 60 to be displayed on the game region 52 are used as information indicating the object 60 to be displayed. Further, information indicating the object 60 represents a correspondence relation between operation timings. Specifically, between operation timings associated with information indicating a common object 60, the position at which the object 60 corresponding to a certain operation timing arrives functions as an appearance position of movement of the object 60 corresponding to another operation timing to which a display start timing closest (or equal) to the certain operation timing is set. Incidentally, when a plurality of records designating the same operation timing are present, the appearance position of the object 60 (the object 60 which will appear next) corresponding to another operation timing may be specified by specifying any one of records designating the same operation timing such as a record which is earlier in a display start timing or a record which is earlier in describing order in which the sequence data 28 is described based on a predetermined specifying condition or the like. Further, information associating the arrival position of each object 60 with the appearance position may be separately described in the sequence data.

In the example of FIG. 8, a display start timing, an operation timing, and an operating player are indicated such that a blue object 60 is displayed on the first operation reference portion 55A which the first player uses as the reference at a start point in time (000) of a fourth beat of a first bar, and the blue object 60 moves along the path W from the first operation reference portion 55A and then arrive at the second operation reference portion 55B at a timing in which “010” elapses from the start point in time of the fourth beat of the first bar. Meanwhile, two objects 60 are displayed on the first operation reference portion 55A at a start point in time (000) of a first beat of a third bar, one objet 60 moves to arrive at the second operation reference portion 55B at a timing in which “010” elapses from the start point in time of the first beat of the third bar, and the other objet 60 moves to arrive at the second operation reference portion 55B at a timing in which “015” elapses from the start point in time of the first beat of the third bar. Furthermore, the object 60 is displayed even at the second operation reference portion 55B at the start point in time (000) of the first beat of the third bar, and the object 60 moves to arrive at the first operation reference portion 55A at a timing in which “012” elapses from the start point in time of the first beat of the third bar. In other words, the three objects 60 are displayed at the start point in time (000) of the first beat of the third bar.

Further, in the example of FIG. 8, a correspondence relation is established between operation timings associated with the same letter “A,” “B,” or “C.” In other words, in the example of FIG. 8, the correspondence relation is indicated such that the arrival position of the object 60 that is displayed on the first operation reference portion 55A at the start point in time (000) of the fourth beat of the first bar and arrives at the second operation reference portion 55B at a timing in which “010” elapses from the start point in time of the fourth beat of the first bar functions as the appearance position of the object 60 that starts to be displayed on the second operation reference portion 55B at a timing in which “010” elapses from the start point in time of the fourth beat of the first bar and moves to arrive at the first operation reference portion 55A at a timing in which “016” elapses from the start point in time of the fourth beat of the first bar. Incidentally, in the example of FIG. 8, for operation timings having the correspondence relation, the same display start timing as each operation timing is set, but a display start timing different from each operation timing may be set. For example, a timing which is slightly earlier than an operation timing corresponding to the object 60 arriving at the appearance position may be set as a display start timing corresponding to each operation timing functioning as the appearance position as far as continuity of the object 60 is maintained. Further, for operation timings having the correspondence relation, an operation timing functioning as the appearance position need not be necessarily set. The object 60 corresponding to an operation timing in which an operation timing functioning as the appearance position is not set, for example, may disappear from the game region 52 since there is no continuity.

Next, processing of the game control unit 11 when the music game is executed by the game machine 1 will be described. The game control unit 11 reads the game program 21, performs an initial setting necessary to execute the music game, and then enters a standby state to receive a game start instruction from a player. For example, the game start instruction includes an operation specifying data used in the game such as selection of music to be played in the game or a difficulty level. A procedure receiving the instruction may be the same as in known games.

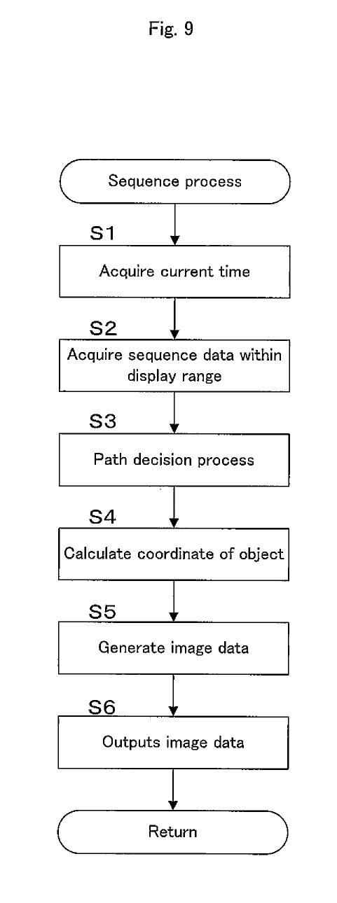

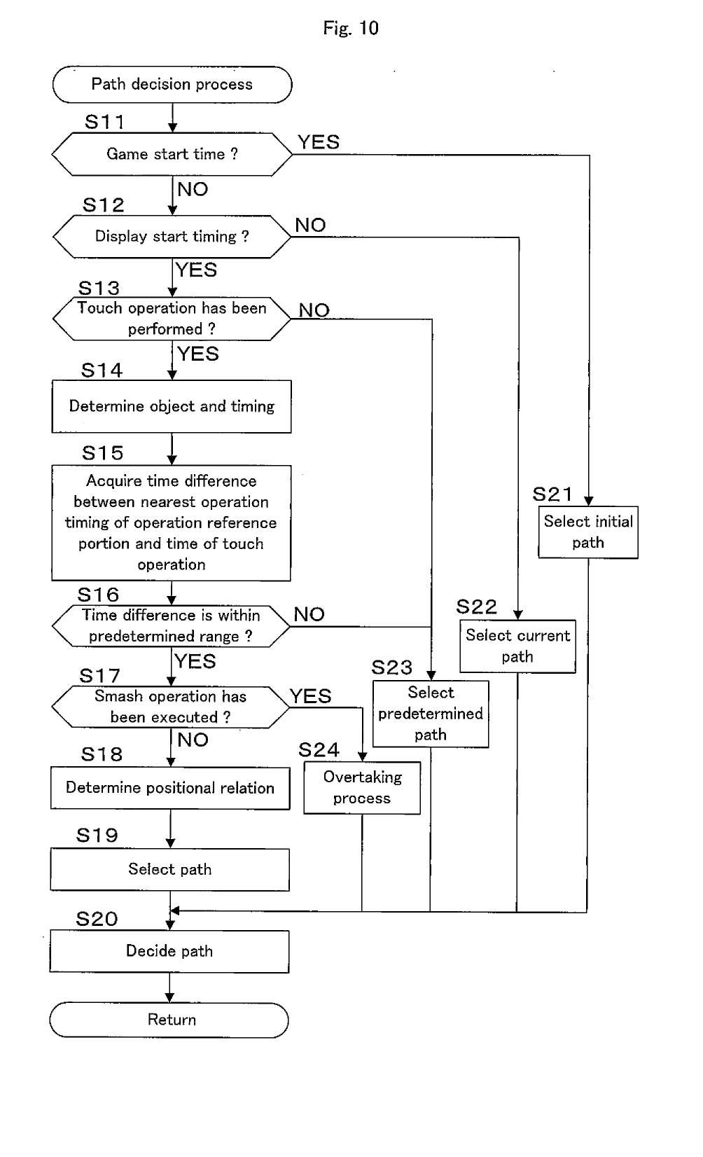

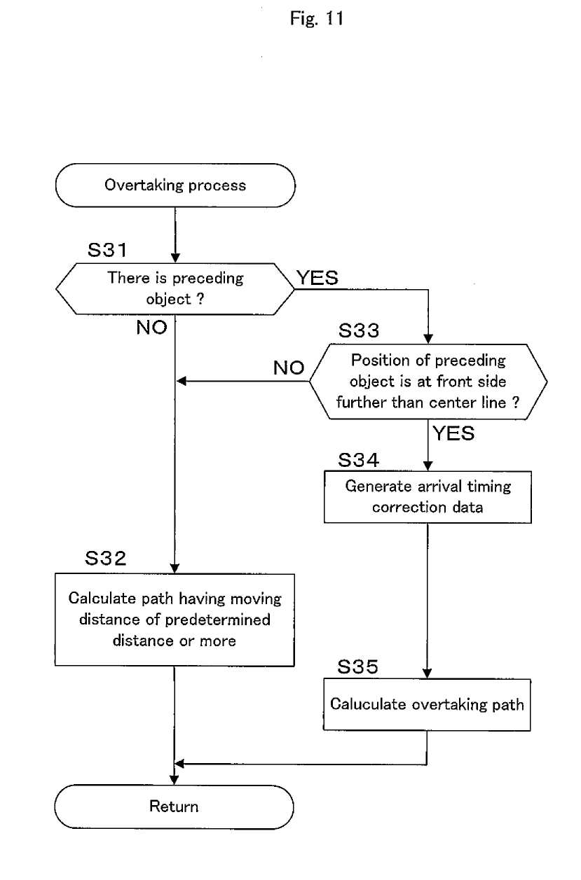

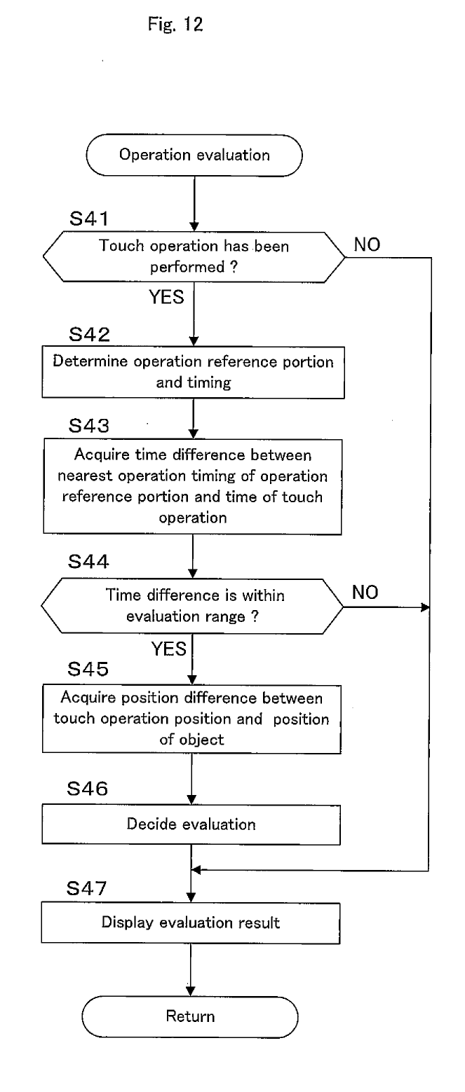

When a game start is instructed, the game control unit 11 causes the music to be reproduced from the speaker 14 by reading the music data 25 corresponding to the music selected by the player and outputting the read music data 25 to the audio output control unit 13. Through this operation, the control unit 10 functions as a music reproducing device. Further, the game control unit 11 causes the game region 52 and the information region 53 to be displayed on the monitor 3 by reading the sequence data 28 corresponding to the player's selection in synchronization with reproduction of the music, generating image data necessary to draw the game region 52 and the information region 53 with reference to the image data 27, and outputting the generated image data to the display control unit 12. Furthermore, as processes necessary to display the game region 52 or the like during execution of the music game, the game control unit 11 repeatedly executes a sequence process routine illustrated in FIG. 9, a path decision process routine illustrated in FIG. 10, an overtaking process routine illustrated in FIG. 11, and an operation evaluation routine illustrated in FIG. 12 at a predetermined period. Incidentally, the sequence processing unit 15 undertakes the routines of FIGS. 9, 10 and 11, and the operation evaluating unit 16 undertakes the operation evaluation routine of FIG. 12.

FIG. 9 illustrates an example of a flowchart of the sequence process routine executed by the sequence processing unit 15. When the routine of FIG. 9 starts, in step S1, the sequence processing unit 15 of the game control unit 11 first acquires a current time in the music. For example, clocking starts, by an internal clock of the game control unit 11, from a reproduction start point in time of the music, and the current time is acquired based on a value of the internal clock. Next, in step S2, the sequence processing unit 15 acquires data of the object 60 in which a display start timing and an operation timing are present within a time length corresponding to a display range of the game region 52 from the sequence data 28. For example, the display range is set to a time range of about two bars of music from the current time to the future.

Next, in step S3, paths W of all objects 60 to be displayed are decided. For example, this decision is actualized by the execution of the routine of FIG. 10. FIG. 10 illustrates an example of a flowchart of the path decision process routine executed by the sequence processing unit 15. When the routine of FIG. 10 starts, in step S11, the sequence processing unit 15 first determines whether or not this time is a start time of the game. When a positive determination is made in step S11, the process proceeds to step S21, but when a negative determination is made, the process proceeds to step S12. In step S21, a previously set path is selected as the path to display the object 60, and then the process proceeds to step S20. For example, the path W3 extending from the rebounding point R1 that is included in the first operation reference portion 55A and is at an n-th position from the left side is set as the previously set path.

Meanwhile, in step S12, it is determined whether or not a display of the object 60 is a display at a display start timing. When a negative determination is made in step S12, that is, when it is determined that a display of the object 60 is not a display at a display start timing and a path to be displayed has been already selected, the process proceeds to step S22. In step S22, the already selected path, that is, a current path is selected as the path to be displayed, and the process proceeds to step S20.

In contrast, when a positive determination is made in step S12, that is, when it is determined that a display of the object 60 is a display at a display timing and a path to be displayed has not been selected, the process proceeds to step S13. In step S13, it is determined whether or not the touch operation has been performed on the operation reference portion 55A or 55B with reference to an output signal of the touch panel 5. When a negative determination is made in step S13, the process proceeds to step S23, but when a positive determination is made, the process proceeds to step S14. In step S23, a predetermined path is selected as the path to display the object 60, and the process proceeds to step S20. For example, the selection of the predetermined path in step S23 is implemented such that a path adjacent to a path on which the object 60 corresponding to the object 60 that starts to be displayed, that is, the object 60 that has immediately previously arrived at the rebounding point R1 or R2 used as the appearance position of the object 60 that starts to be displayed has been displayed, or a path which is at the shortest distance from the appearance position toward the operation reference portion 55A or 55B to arrive is set as the predetermined path.

Meanwhile, in step S14, an operation reference portion on which the touch operation has been performed and a timing (a time in the music) at which the touch operation has been performed are determined based on a signal output from the touch panel 5. Next, in step S15, a nearest operation timing described in the sequence data 28 with respect to the operation reference portion on which the touch operation has been performed, that is, an operation timing which is closest in time and associated in the sequence data 28 with respect to the operation reference portion on which the touch operation has been performed is specified, and a time difference between the operation timing and a time at which the touch operation has been performed is acquired.

Next, in step S16, the sequence processing unit 15 determines whether or not each player's operation is appropriate by determining whether or not the time difference is within a predetermined range. A predetermined time range around an operation timing of a comparison target is set as the predetermined range. When a negative determination is made in step S16, the process proceeds to step S23. In step S23, the predetermined path is selected as the path to display the object 60 as described above, and then the process proceeds to step S20. In contrast, when a positive determination is made in step S16, the process proceeds to step S17.

In step S17, the sequence processing unit 15 determines whether or not the smash operation has been executed. For example, the determination of whether or not the smash operation has been executed is performed as follows. First, the presence or absence of a continuous change in the touch operation position at which the touch operation has been performed is determined based on a signal output from the touch panel 5. When it is determined that the touch operation position has been not continuously changed, it is determined that the smash operation has not been executed. When it is determined that the touch operation position has been continuously changed, a direction and velocity of the change are calculated. Then, when it is determined that both the direction and velocity of the continuous change are within a predetermined range, it is determined that the smash operation has been executed. Incidentally, as the predetermined range, for example, a range is set such as when an angle formed between the direction of the continuous change and the operation reference portion is smaller than a predetermined value (when the continuous change is further directed to the side wall 52R or 52L) or when the velocity of the continuous change is faster than the moving velocity of the object 60 set as the velocity corresponding to the smash operation. Meanwhile, when a positive determination is made in step S17, the process proceeds to step S24, but when a negative determination is made in step S17, the process proceeds to step S18.

Next, in step S18, the sequence processing unit 15 determines the positional relation between the operation position at which the touch operation has been performed on the operation reference portion 55A or 55B and the position of the object 60 based on a signal output from the touch panel 5. Specifically, any one of the contact region S, the right region R, the left region L, and the remaining region of the object 60 that starts to be displayed or the object 60 that has most recently arrived at the appearance position is determined as the touch position. Next, in step S19, a path to arrange the object 60 is selected according to the positional relation determined in step S18. For example, the selection of the path is performed as follows. First, any one of the right region R, the left region L, the contact region S, and the remaining region is assigned to each path W. Next, a path assigned to the touch position is selected from among a plurality of paths W extending from the appearance position based on the determination result in step S18. In the example of FIG. 3, in the rebounding point R1, the straight line path W2 is assigned to the contact region Sand the remaining region, the first right path W3 is assigned to the left region L, and the first left path W1 is assigned to the right region R. Thus, the straight line path W2 is selected when the contact region S or the remaining region of the object 60 is touched, the first left path W1 is selected when the right region R is touched, and the first right path W3 is selected when the left region L is touched.

Meanwhile, in step S24, the overtaking process is executed. For example, the overtaking process is actualized by executing the routine of FIG. 11. FIG. 11 illustrates an example of a flowchart of the overtaking process routine executed by the sequence processing unit 15. When the routine of FIG. 11 starts, in step S31, the sequence processing unit 15 determines whether or not there is a preceding object 60. Specifically, it is determined whether or not there is an object that moves toward operation reference portion at which a smashed object 60 is to arrive and is arranged at the position ahead of the smashed object 60. When it is determined in step S31 that there is a preceding object 60, the process proceeds to step S33, but when it is determined that there is no preceding object 60, the process proceeds to step S32.

In step S32, a path having a moving distance of a predetermined distance or more is calculated as the moving path of the object 60, and then the current routine ends. For example, the calculation of the path having the predetermined distance or more is performed as follows. First, a moving time of a target object 60 is calculated based on an operation timing described in the sequence data 28 and a current time. Next, a predetermined velocity of a predetermined value or more is acquired as a moving velocity corresponding to the smash operation, and a distance necessary for the moving path is calculated based on the acquired moving velocity and the calculated moving time. Furthermore, a direction in which the smash operation is executed is acquired. Next, so that the calculated moving distance is secured, calculated are the number of rebounds with both side walls 52R and 52L and the rebound points such as a rebound point with a side wall positioned in a direction in which the acquired direction of the smash operation is considered in both side walls 52R and 52L and a rebound point with a side wall at the opposite side after rebounded at the rebound point. The calculation of the rebound point is executed so that a value of an incidence angle of a path connecting the rebound points with each other is as close as possible to a value of a reflection angle. Then, a path obtained by connecting the calculated rebound points in order from the appearance position to the operation reference portion at the arrival position is calculated as the path of the predetermined distance or more.

Meanwhile, in step S33, it is determined whether or not the position of the preceding object 60 is at the front side further than the center line C of the game region 52. When it is determined that the position of the preceding object 60 is positioned at the operation reference portion side (including the position of the center line C of the game region 52) at the arrival position further than the center line C of the game region 52, the process proceeds to step S32. In contrast, when it is determined that the position of the preceding object 60 is at the front side further than the center line C of the game region 52, the process proceeds to step S34.

In step S34, arrival timing correction data in which a arrival timing at which the preceding object 60 is to arrive at the operation reference portion is switched with an arrival timing at which the smashed object 60 is to arrive at the operation reference portion is generated. As an example of the arrival timing correction data, data in which information of an arrival timing is added to information indicating the object 60 and an operation timing is generated. Next, in step S35, an overtaking path is calculated as the moving path of the smashed object 60, and then the current routine ends. For example, the calculation of the overtaking path is performed as follows. First, an arrival timing of the smashed object 60 is acquired based on the arrival timing correction data generated in step S34, and a moving time of the smashed object 60 is calculated based on the acquired arrival timing and the current time. Next, a predetermined velocity of a predetermined value or more is acquired as the moving velocity corresponding to the smash operation, and the moving distance to arrive at the operation reference portion at the arrival position at an arrival timing set to the arrival timing correction data is calculated based on the acquired moving velocity and the calculated moving time. Furthermore, a direction in which the smash operation is executed is acquired. Next, so that the calculated moving distance is secured, calculated are the number of rebounds with both side walls 52R and 52L and the rebound points such as a rebound point with a side wall positioned in a direction in which the acquired direction of the smash operation is considered in both side walls 52R and 52L, and a rebound point with a side wall at the opposite side after rebounded at the rebound point. The calculation of the rebound point is executed so that a value of an incidence angle of a path connecting the rebound points with each other is as close as possible to a value of a reflection angle. Then, a path obtained by connecting the calculated rebound points in order from the appearance position to the operation reference portion at the arrival position is calculated as the path of the predetermined distance or more.

Incidentally, in steps S32 and S35, the predetermined velocity of the predetermined value or more which is acquired as the moving velocity may be set so as to change according to the velocity of the smash operation, and may be set so as to become uniformly the same velocity when the velocity of the smash operation is a predetermined value or more. Furthermore, the predetermined velocity of the predetermined value or more used in step S35 may be the same as that used in step S32, and different values may be prepared in steps S32 and S35. Further, the path of the predetermined distance or more or overtaking path may be selected according to the direction and velocity of the smash operation from among paths corresponding to smash operations which are previously set for each of the rebounding points R1 and R2. Further, the direction of the path calculated in step S32 or S35 need not necessarily match the direction of the smash operation. It is preferable that the direction of the smash operation be considered to some extent. Further, the direction of the smash operation may not be considered. For example, a direction considered as the moving direction may be a direction which is determined in advance or a direction decided by a lottery using a random number. Furthermore, a path having no rebound point on any of both side walls 52R and 52L may be calculated as the overtaking path.

Referring to the routine of FIG. 10, in step S20, a path selected in each of step S19 and steps S21 to S24 is decided as a path to display the object 60, and then the current routine ends.

Referring back to the routine of FIG. 9, in step S4, the sequence processing unit 15 calculates coordinates of all objects 60 to be displayed on each path W in the game region 52. For example, this calculation is performed as follows. First, the path W to display each object 60 included in the display range is determined based on the processing result of step S3. Furthermore, the arrival timing correction data generated in step S34 of the routine of FIG. 11 is acquired. Next, the position of each object 60 from the operation reference portion 55A or 55B in the time axis direction (that is, the moving direction of the object 60) is determined according to the moving direction (the operation reference portion 55A or 55B at the arrival position) corresponding to each object 60 and a time difference between each operation timing and a current time. At this time, when a record of an arrival timing corrected using information indicating the object 60 and an operation timing as a key is presented in the acquired arrival timing correction data, the position of each object 60 in the time axis direction from the operation reference portion 55A or 55B is determined according to the time difference between the arrival timing on arrival timing correction data and the current time rather than the position corresponding to the time difference between the operation timing and the current time. Specifically, a record of an operation timing corresponding to the smashed object 60 and a record of an operation timing corresponding to an object 60 preceding the smashed object 60 are present as records on the arrival timing correction data. Through this operation, it is possible to acquire the path W to arrange each object 60 and coordinates of each object 60 necessary to arrange each object 60 on the corresponding path W along the time axis from the operation reference portion 55A or 55B.

Next, in step S5, the sequence processing unit 15 generates image data necessary to draw the game region 52 based on the coordinates of the object 60 calculated in step S4. Specifically, image data that causes each object 60 to be arranged on the calculated coordinates is generated. An image of the object 60 or the like may be acquired from the image data 27. Next, in step S6, the sequence processing unit 15 outputs the image data to the display control unit 12. As a result, the game region 52 is displayed on the monitor 3. When the process of step S6 ends, the sequence processing unit 15 ends the current sequence process routine. By executing repeatedly the above-described process, the object 60 is displayed on the designated operation reference portion 55A or 55B at a display start timing described in the sequence data 28, and the object 60 moves between the two operation reference portions 55A and 55B to arrive at the designated operation reference portion 55A or 55B at an operation timing described in the sequence data 28. Further, by using the arrival timing correction data for the coordinates calculation in step S4, it is possible to actualize a display so that the smashed object 60 overtakes the preceding object 60 in order to indicate an operation timing which is originally indicated by the preceding object 60, and the moving velocity of the preceding object 60 decreases in order to indicate an operation timing which is originally indicated by the smashed object 60.

Next, the operation evaluation routine of FIG. 12 will be described. When the operation evaluation routine of FIG. 12 starts, in step S41, the operation evaluating unit 16 first determines the presence or absence of the touch operation on the object 60 with reference to an output signal of the touch panel 5. At this time, when the position other than the operation reference portions 55A and 55B is touched, it is determined no touch operation has been performed. When it is determined no touch operation has been performed, the operation evaluating unit 16 ends the current routine, and when it is determined the touch operation has been made, the process proceeds to step S42. In step S42, the operation evaluating unit 16 determines a timing (a time in the music) at which the touch operation has been made based on a position signal output from the touch panel 5. Next, in step S43, the operation evaluating unit 16 specifies a nearest operation timing described in the sequence data 28 with respect to the operation reference portion on which the touch operation has been performed, that is, an operation timing which is closest in time in the sequence data 28 with respect to the operation reference portion on which the touch operation has been performed, and acquires a time difference between the operation timing and a time at which the touch operation has been performed.

Next, in step S44, the operation evaluating unit 16 determines whether or not the player's operation is appropriate by determining whether or not the time difference is within the evaluation range. A predetermined time range around an operation timing of a comparison target is set as the evaluation range. For example, a plurality of steps of levels are set centering on an operation timing, and a time range in which the levels are set is dealt as the evaluation range. When it is determined in step S44 that the time difference is outside the evaluation range, the operation evaluating unit 16 ends the current routine. In contrast, when it is determined that the time difference is within the evaluation range, the process proceeds to step S45. In step S46, the operation evaluating unit 16 specifies an operation position at which the touch operation has been performed on the operation reference portion 55A or 55B and an operation timing which is closest in time in the sequence data 28 with respect to the operation reference portion at which the touch operation has been performed, and acquires a position difference between the operation position and the arrival position of the object 60 indicating the operation timing.

Next, in step S46, the operation evaluating unit 16 decides an evaluation on the player's touch operation based on the time difference acquired in step S44 and the position difference acquired in step S45. For example, this evaluation is implemented as follows. First, the evaluation related to the time difference is actualized by determining whether or not a timing of the touch operation belongs to any one of a plurality of levels set in the time range. The plurality of levels are set such that the time range is divided in units of predetermined time periods, and the touch operation that belongs to a division close to an operation timing of each division is evaluated high. Further, the evaluation related to the position difference is actualized by comparing the center position of the object 60 and the touch operation position. For example, in the evaluation of the position difference, a region up to twice the diameter of the object 60 is evaluated as “GOOD”, and the remaining region is evaluated as “MISS.” Alternatively, the inner side further than the outer circumference of the object 60 may be evaluated highest, a predetermined evaluation range may be set such that an evaluation is steadily lowered in units of certain distances from the outer circumference, and the evaluation may be determined according to the evaluation range to which the position of the touch operation belongs to. Thereafter, the operation evaluating unit 16 proceeds to step S47, and controls an output to the display control unit 12 such that the evaluation result is displayed on at least one of the game region 52 and the information region 53. When the process of step S47 is completed, the operation evaluating unit 16 ends the current routine. Incidentally, in the example of FIG. 12, step of acquiring the difference between the position of the object and the position of the touch operation may be executed before step of acquiring the difference between the operation timing nearest to the operation reference portion and the time at which the touch operation has been performed. Further, in the example of FIG. 12, the evaluation of the position difference is performed such that “GOOD” or “MISS” is evaluated according to a region. However, when the position difference is outside a predetermined range, similarly to step S44, the subsequent process may be skipped, and then the current routine may end. In this case, for example, when an operation on the first operation reference portion 55A is required, an operation on an inappropriate position outside a predetermined range such as an operation executed on the second operation reference portion 55B can be excluded from an evaluation target.

As described above, according to this embodiment, each player can increase the moving velocity of the object 60 moving toward the operation reference portion of the opponent player by selecting the moving path of the object 60 and further executing the smash operation. Thus, it is possible to broaden the scope of options for improving a difficulty level of the game of the opponent player. Furthermore, the arrival timing of the smashed following object 60 is switched with the arrival timing of the preceding object 60 depending on the position of the preceding object 60. As a result, it is possible to increase the moving velocity of the following object 60 while decreasing the moving velocity of the preceding object 60. Thus, an effect by which the following object 60 overtakes the preceding object 60 can be rendered. Accordingly, a difficulty level of the game can be variously changed, and thus amusement of the game can be improved.

In the above-described embodiment, the external storage device 20 of the game machine 1 functions as a music data storage device and a sequence data storage device. Further, the control unit 10 functions as a game region presenting device and a mark display control device by executing the routines of FIG. 9, FIG. 10, and FIG. 11 through the sequence processing unit 15. Furthermore, the control unit 10 functions as an evaluating device by executing the routine of FIG. 12 through the operation evaluating unit 16.

The above-described embodiment has been described in connection with the example in which three paths W extend from one rebounding point R1 or R2. However, the number of paths extending each rebounding point is not limited. Thus, it is possible to set a number of paths omnidirectionally extending from each rebounding point. Further, it is possible to set a number of rebounding points R1 or R2 included in the operation reference portion 55A or 55B. In other words, a plurality of paths may be set such that the operation indication mark is omnidirectionally movable between the operation reference portions at all positions. Furthermore, a number of rebound points with both side walls 52R and 52L of the game region 52 and a number of paths starting from the rebound point may be set. Thus, a number of paths up to the rebound point and a number of paths after rebounding can be set. Further, the above-described embodiment has been described in connection with the example in which the object 60 is divided into four regions, the moving path is decided by comparing the position of the touch operation with the four regions of the object 60. However, the present invention is not limited to this embodiment. The operation indication mark may be divided into a number of regions according to a number of paths set to a game region. Thus, it is possible to cause the operation indication mark to move along a free path between the operation reference portions through the touch operation. Further, the present invention is not limited to the embodiment in which the operation indication mark is divided into a plurality of regions. For example, the moving path of the operation indication mark may be decided by comparing a fixed position such as the center position of the operation indication mark with the position of the touch operation.

The above-described embodiment has been described in connection with the example in which the path along which the operation indication mark moves is disposed between the operation reference portions. However, the present invention is not limited to this embodiment. For example, each path may extend up to both ends of the game region beyond each operation reference portion. In this case, for example, each operation indication mark moves so as to arrive at each operation reference portion at an operation timing described in the sequence data, and in the case in which an appropriate operation is not made on the operating unit when each operation indication mark arrives at the operation reference portion, the operation indication mark can be caused to move beyond the operation reference portion and collide with an end portion of the game region. In this case, preferably, a rebounding point is provided also on the end portion of the game region, and the position of the end portion of the game region at which the operation indication mark arrives serves as the appearance position of movement of a next operation indication mark. Further, in the above-described embodiment, the object 60 disappears at the arrival position when arrived, the arrival position serves as the appearance position of the object 60 corresponding to the operation timing indicated by the common object 60, and thus the object 60 moves as if the object 60 rebounds between the operation reference portions 55A and 55B. However, the movement of the object 60 is not limited to this embodiment. For example, the operation indication mark may not disappear each time when arrived at the rebounding point at the arrival position, and the operation indication mark may actually rebound from the rebounding point using the common object 60 as is. In this case, for example, after rebounding from the rebounding point, a color of the operation indication mark may be changed to a color corresponding to the operation reference portion to arrive next. Thus, information about the operation reference portion toward which the operation indication mark moves can be given.

Further, in order to prevent the moving velocity of the operation indication mark from becoming too fast to be appropriate for an operation indication, a limiting device that limits a change of the moving path to a path in which the moving velocity of the operation indication mark falls within a predetermined range may be further provided. In this case, the control unit 10 may be configured so as to function as the limiting device. When the control unit 10 is configured so as to function as the limiting device, for example, in the process of step S18 of the path decision process routine illustrated in FIG. 10 or the process of steps S32 and S34 of the overtaking process routine illustrated in FIG. 11, selection or a calculation of a path is preferably limited to a predetermined path in which the moving velocity is within a predetermined range.

In the above-described embodiment, the moving path along which the object 60 moves toward the next operation reference portion is decided according to the positional relation between the position of the touch operation and the position of the object 60. However, the decision of the moving path is not limited to the example according to the positional relation. For example, the moving path may be decided according to an operation designating a direction such as an operation in which the position of the touch operation continuously changes.

In the above-described embodiment, in the determination on whether or not a specific operation has been executed, it is determined that a specific operation has been executed when both the direction and the velocity of the continuous change of the touch operation position are within the predetermined value range, but this determination is not limited to this operation. For example, when either the direction or the velocity of the continuous change of the touch operation position is within the predetermined value range, it may be determined that the smash operation has been executed. Further, for example, it may be determined that a specific operation has been executed when a specific positional relation is established according to the positional relation between the operation position when the operation reference portion is touched and the operation indication mark. Furthermore, in the above-described embodiment, when a specific operation is executed and the position condition that the position of the preceding object 60 is positioned in front of the center line C is satisfied, the arrival timing of the following object 60 is switched with the arrival timing of the preceding object 60, but an implementation can be made even when the position condition is not provided. Further, in the above-described embodiment, it is determined that the position condition is satisfied when the position at the operation reference portion side on which the touch operation is executed further than the center line C is applied as a predetermined position, and an preceding operation indication mark is positioned on the operation reference portion side on which the touch operation is executed further than the center line C, but the predetermined position is not limited to this position. For example, the position at the operation reference portion side on which the touch operation is executed further than an intermediate position of the moving path may be applied as the predetermined position. As far as the change of the moving time of the operation indication mark is restricted to a predetermined range, any positions may be applied as the predetermined position.

Further, in the above-described embodiment, at least execution of a predetermined operation is used as the switching condition in which the arrival timing of the preceding operation indication mark is switched with the arrival timing of the following operation indication mark, but the switching condition is not limited to this embodiment. For example, switching between the arrival timing of the preceding operation indication mark and the arrival timing of the following operation indication mark may be executed according to a progress state of the game or as an option during development of the game without being affected by an operation on the operating unit. In other words, switching between arrival timings may be executed according to a predetermined condition such as a specific operation, a development state of the game, or a progress state of the game.

Further, in the above-described embodiment, the moving path of the object 60 changes according to the touch operation, but the present invention is not limited to the configuration in which the moving path changes according to the player's operation. For example, the moving path may change according to the development or rendition of the game. In other words, the moving path of the object may change by a predetermined condition such as an operation on the operating unit or the development or rendition of the game. For the rendition of the game, as an example in which the moving path of the object 60 changes, the moving path of the object 60 may be decided according to a time interval between a certain operation timing and a next operation timing. Further, for example, as an example of the predetermined condition, the moving range of the operation indication mark may be restricted by an option prepared during the progress of the game, and the moving path may change by this restriction. Alternatively, the moving velocity of the operation indication mark may increase by another option prepared during the progress of the game, and thereby the moving path may change with an increase of the moving velocity. Furthermore, the moving path may change such that the moving velocity changes according to the player's level.

Further, in the above-described embodiment, an operation timing is described as the timing described in the sequence data, but a display duration time may be described instead of an operation timing. In this case, an operation timing can be indicated by moving the object 60 so as to arrive at any one of operation reference portions at a timing in which the display duration time elapses from a display start timing.

Further, in the above-described embodiment, there is executed the game which is played by a plurality of players so that players or a game machine itself functions as another player, but the present invention is not limited to this embodiment. For example, as another example, a game executed by the game machine 1 may be actualized such that only the first operation reference portion 55A is set so as to correspond to the operating unit, and the second operation reference portion 55B is arranged so as to simply function as a wall to rebound the operation indication mark. And, the game may be executed such that only the first operation reference portion 55A is provided on the game screen, the operation indication mark rebounds from a wall serving as a reference portion provided in the boundary of the game region, and the operation indication mark moves so as to arrive at only the first operation reference portion 55A, or walls arranged at the positions facing the first operation reference portion 55A (or the other walls and the like)and the first operation reference portion 55A at a timing described in the sequence data. In this case, a game that can variously change a difficulty level of the game and be played by one player can be actualized. Further, in this case, for example, the walls arranged at the positions facing the first operation reference portion 55A and the first operation reference portion 55A function as a plurality of reference portions according to the present invention. Further, a reference timing may be used as a timing described in the sequence data instead of an operation timing, and among reference timings, an arrival timing at the first operation reference portion 55A may serve as an operation timing.

Further, in the above-described embodiment, one object is displayed as a preceding object, but the number of preceding objects is not limited to this embodiment. The number of preceding objects may be two or more. In this case, an object which is a switching target whose arrival timing is to be switched with a following object may be randomly decided from among a plurality of preceding objects. Further, for example, an object closest or farthest from a following object may be decided as the switching target by applying a position condition. Furthermore, an object having the earliest arrival timing may be decided as the switching target by applying a condition of an arrival timing. For example, these embodiments can be actualized by additionally performing a process of determining whether or not various kinds of conditions mentioned above have been satisfied before step S33 after a positive determination is made in step S31 in the process of FIG. 11.

In the above-described embodiment, a rectangular region is used as the game region 52, but the game region is not limited to this embodiment. Regions of various shapes such as polygonal shape or a circular shape may be used as the game region. Further, in the above-described embodiment, the two operation reference portions 55A and 55B respectively corresponding to both ends of the game region 52 in the longitudinal direction are provided, but the number of operation reference portions is not limited to two (2). For example, a region in which three or more operation reference portions are set to the periphery thereof may be used as the game region so that three or more players can play the game.

In the above-described embodiment, the control unit 10 serving as the evaluating device performs an evaluation by comparing an operation timing of a touch operation with an operation timing described in the sequence data, but a function of the evaluating device may not be provided. In this case, a game machine of a match-up type in which an operation is made in tune with a rhythm of music while inducing an opponent player to make a mistake can be implemented.

In the above-described embodiments, the touch panel is used as the input device, but the input device is not limited to this embodiment. For example, as far as at least one operating unit is included, there may be used input devices having various configurations such as a controller in which a plurality of push buttons serving as an operating unit is provided.

In the above-described embodiments, the game machine 1 is configured as a music game machine in which music is reproduced, and an operation indication mark moves toward an operation reference portion based on a played time of the music. However, the present invention is not limited to this embodiment. The game machine 1 can execute various kinds of games as far as an operation timing is indicated through a video. Furthermore, the game system of the invention may be actualized in appropriate embodiments such as a game machine for business use installed in commercial facility, a stationary game machine for home use, a portable game machine, or a game system actualized using a network.

1. A game system comprising:
a display device that displays and outputs a game screen;
an input device including at least one operating unit;
a sequence data storage device that stores sequence data in which an operation timing on the operating unit during a game is described;
a game region presenting device that causes a game region in which a plurality of reference portions arranged apart from each other are set to be displayed on the game screen of the display device; and
a mark display control device that displays an operation indication mark for indicating an operation on the operating unit while moving the operation indication mark in the game region such that the operation indication mark arrives at at least one of the plurality of reference portions at an operation timing indicated by the sequence data, wherein
mark information designating any one of a plurality of operation indication marks is further described in the sequence data in association with each operation timing, and
the mark display control device causes the plurality of operation indication marks respectively corresponding to operation timings to be displayed based on the mark information of the sequence data, switches a timing to arrive at a reference portion between an operation indication mark corresponding to a certain operation timing displayed on the game region and an operation indication mark corresponding to a subsequent operation timing to arrive at the reference portion at which an indication mark corresponding to the certain operation timing is to arrive subsequently to the certain operation timing when a specific condition is satisfied, and displays the operation indication marks while moving the operation indication marks such that the operation indication mark corresponding to the certain operation timing arrives at the reference portion at an arrival position of the operation indication mark corresponding to the certain operation timing at the subsequent operation timing, and the operation indication mark corresponding to the subsequent operation timing arrives at the certain operation timing.

2. The game system according to claim 1, wherein the mark display control device determines that the specific condition has been satisfied when at least a specific operation has been executed on the operating unit.

3. The game system according to claim 2, wherein the mark display control device determines that the specific operation has been executed when an operation designating at least one of a predetermined direction and a predetermined velocity has been executed.

4. The game system according to claim 3, wherein
the input device is configured so as to detect an operation position of an operation on the operating unit, and
the mark display control device determines whether or not the predetermined direction has been designated based on a direction in which the operation position continuously changes and whether or not the predetermined velocity has been designated based on the velocity of a change at which the operation position continuously changes, with reference to a detection result of the input device.

5. The game system according to claim 2, wherein the mark display control device determines that the specific condition has been satisfied when a position condition that the operation indication mark corresponding to the certain operation timing is positioned at a predetermined position of the game region when the specific operation is executed has been further satisfied.

6. The game system according to claim 5, wherein
the game region presenting device causes a region in which a plurality of reference portions extending in the form of a straight line are set apart from each other to be displayed as the game region,
the mark display control device determines that the operation indication mark is positioned at the predetermined position and determines that the position condition is satisfied when the specific operation is executed and the operation indication mark corresponding to the certain operation timing is positioned at a side of a specific reference portion used to indicate an operation on the operating unit on which the specific operation is executed further than a center line which is in parallel with the specific reference portion and arranged at the position at which the game region is equally divided in half.

7. The game system according to claim 5, wherein the mark display control device displays the operation indication mark such that the operation indication mark corresponding to the subsequent operation timing moves along a moving path having a moving distance of a predetermined distance or more when the specific operation is executed but the position condition is not satisfied.

8. The game system according to claim 1, wherein
the input device includes a plurality of operating units,
an operation timing on each of the plurality of operating units during the game is described in the sequence data in association with information indicating any one of the plurality of operating units,
the game region presenting device causes a game region in which each of reference portions respectively corresponding to the plurality of operating units among the plurality of reference portions is set as an operation reference portion to be displayed on the game screen of the display device,
the mark display control device displays the operation indication mark while moving the operation indication mark in the game region such that the operation indication mark arrives at the operation reference portion corresponding to the operating unit associated with an operation timing indicated by the sequence data at the operation timing, and displays each operation indication mark while moving each operation indication mark such that when the specific condition is satisfied, a timing to arrive at the operation reference portion is switched between the operation indication mark corresponding to the certain operation timing and the operation indication mark corresponding to the subsequent operation timing, the operation indication mark corresponding to the certain operation timing arrives at the operation reference portion at the arrival position of the operation indication mark corresponding to the certain operation timing at the subsequent operation timing, and the operation indication mark corresponding to the subsequent operation timing arrives at the certain operation timing.

9. The game system according to claim 1, wherein a touch panel arranged on the display device so as to cover the game region is used as the input device.

10. The game system according to claim 1, wherein the game region presenting device causes a region which is formed in the form of a quadrangle and includes two operation reference portions extending in the form of a straight line which are set at both one ends of the quadrangle to face each other to be displayed on a game screen of the display device as the game region.

11. The game system according to claim 1, further comprising an evaluating device that evaluates an operation in at least one operating unit based on a timing of an operation on the operating unit and an operation timing designated by the sequence data.

12. The game system according to claim 1, further comprising:
an audio output device that reproduces and outputs a sound;
a music data storage device that stores music data used to reproduce music; and
a music reproducing device that reproduces the music through the audio output device based on the music data, and wherein
an operation timing of each of the plurality of operating units during reproduction of the music is described in the sequence data.

13. A control method of controlling a computer incorporated into a game machine comprising: a display device that displays and outputs a game screen; an input device including at least one operating unit; a sequence data storage device that stores sequence data in which an operation timing on the operating unit during a game is described, wherein the control method of controlling the computer comprises the steps:
a game region presenting step that causes a game region in which a plurality of reference portions arranged apart from each other are set to be displayed on the game screen of the display device; and
a mark display control step that displays an operation indication mark for indicating an operation on the operating unit while moving the operation indication mark in the game region such that the operation indication mark arrives at at least one of the plurality of reference portions at an operation timing indicated by the sequence data, wherein
mark information designating any one of a plurality of operation indication marks is further described in the sequence data in association with each operation timing, and
the mark display control step further includes a step that causes the plurality of operation indication marks respectively corresponding to operation timings to be displayed based on the mark information of the sequence data, switches a timing to arrive at a reference portion between an operation indication mark corresponding to a certain operation timing displayed on the game region and an operation indication mark corresponding to a subsequent operation timing to arrive at the reference portion at which an indication mark corresponding to the certain operation timing is to arrive subsequently to the certain operation timing when a specific condition is satisfied, and displays the operation indication marks while moving the operation indication marks such that the operation indication mark corresponding to the certain operation timing arrives at the reference portion at an arrival position of the operation indication mark corresponding to the certain operation timing at the subsequent operation timing, and the operation indication mark corresponding to the subsequent operation timing arrives at the certain operation timing.
